(19) United States
(12) Patent Application Publication
(10) Pub. No.: US 2015/0024364 A1
(43) Pub. Date: Jan. 22, 2015

(54) OCULAR SURGERY TRAINING DEVICE

(71) Applicant: Princeton Wen-Yuan Lee, Nantou County (TW)

(72) Inventor: Princeton Wen-Yuan Lee, Nantou County (TW)

(21) Appl. No.: 14/075,950

(22) Filed: Nov. 8, 2013

(30) Foreign Application Priority Data
Jul. 18, 2013 (TW) 102213604

(51) Int. Cl. G09B 23/32

(52) U.S. Cl. CPC G09B 23/32
USPC 434/271

(57) ABSTRACT

Disclosed is an ocular surgery training device including a base body, an eye means, and a surgery model component. The base body is provided with a receiving seat. The eye means is provided on the base body, and the eye means includes an eye base and a cover body. The eye base has a containing groove, and the cover body has an operation channel communicated with the containing groove. The surgery model component is replaceably provided between the receiving seat and the containing groove. Thereby the surgery model component in the eye means can be rapidly replaced by others for simulating various ocular surgeries.

### FIELD OF THE INVENTION

The present invention relates to an ocular surgery training device, and more particularly to an ocular surgery training device with a plurality of replaceable surgery models.

### BACKGROUND OF THE INVENTION

Eyes, the window of the soul, distinguishing shape, color and brightness of an object, are deemed as one of the most delicate organs of human body. The health of the eyes is so important that there are ocular surgeries for treating eye diseases.

The ocular surgery is accordingly an exquisite surgery that requires skilled ocular surgeons. For improving the skill of ocular surgeons, the ocular surgeons have to receive a complete ocular surgery training before starting the practice of ocular operation.

The ocular surgery training is usually a simulation surgery that is processed by use of surgical equipment to practice the ocular surgery on a plastic eye or on an animal eye. Conventional training requires the use of a lot of plastic eyes and animal eyes, since a complete ocular surgery training involves a lot of procedures and various methods. It thus increases the cost for the training and wastes resources.

### SUMMARY OF THE INVENTION

In view of the description above, there exists a need to not only lower the cost of training the ocular surgeon while also reducing the wasting of resources, but to also provide multiple training opportunities under various conditions in order to make the trained ocular surgeon become familiar with the whole procedure of ocular operations.

Accordingly, an aspect of the present invention is to provide an ocular surgery training device to solve those problems described above as well as others.

The ocular surgery training device comprises a base body, an eye means, and a surgery model component. The base body is provided with a receiving seat. The eye means is provided on the base body, and the eye means includes an eye base and a cover body. The eye base has a containing groove, and the cover body has an operation channel communicated with the containing groove. The surgery model component is replaceably provided between the receiving seat and the containing groove.

According to an embodiment of the present invention, the eye means further includes a sclera component surrounding the eye base, the sclera component is formed with a hollow bore that is corresponding to the cover body.

According to an embodiment of the present invention, the sclera component is formed with an engaging trough for being engaged with the cover body.

According to an embodiment of the present invention, the device further comprises an underlay component for adjusting height of the surgery model component that is disposed on the underlay component.

According to an embodiment of the present invention, the eye means is provided on the base body through a seat body, and an elastic component is connected between the seat body and the eye base.

According to an embodiment of the present invention, the base body has an eye seat, and the eye means is disposed on the eye seat.

According to an embodiment of the present invention, the device further comprises a gear component rotatably mounted on the base body, wherein the eye seat is also rotatably mounted on the base body and is engaged with the gear component.

According to an embodiment of the present invention, the device further comprises a sensing wire provided around the eye means.

According to an embodiment of the present invention, the device further comprises a mask body covering the base body, wherein the mask body is formed with an orbital bore that is corresponding to the eye means.

The surgery model component is replaceable and may be provided on the receiving seat or in the containing groove. Also, the surgery model component can be used multiple times, thereby reducing training cost and preventing resource waste. In the present invention, various surgery model components are provided to help the ocular surgeon to be more familiar with surgery procedures. The eye means of the present invention can be vibrated for providing a more lifelike feel. In addition, a warning effect may be provided to give notice to the ocular surgeon to operate during the training of the ocular surgery with a more proper force.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a stereogram illustrating the ocular surgery training device of an embodiment according to the present invention;

FIG. 2 is an explosion diagram illustrating the ocular surgery training device of an embodiment according to the present invention;

FIG. 3 is an explosion diagram illustrating an eye means of the ocular surgery training device of an embodiment according to the present invention;

FIG. 4 is sectional view illustrating the ocular surgery training device of an embodiment according to the present invention.

### DETAILED DESCRIPTION OF THE PREFERRED EMBODIMENTS

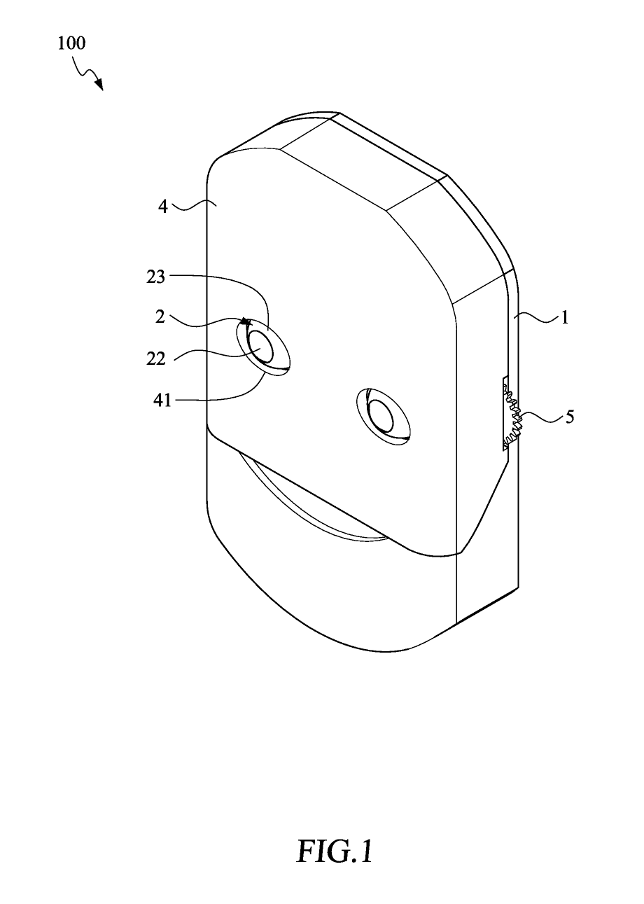

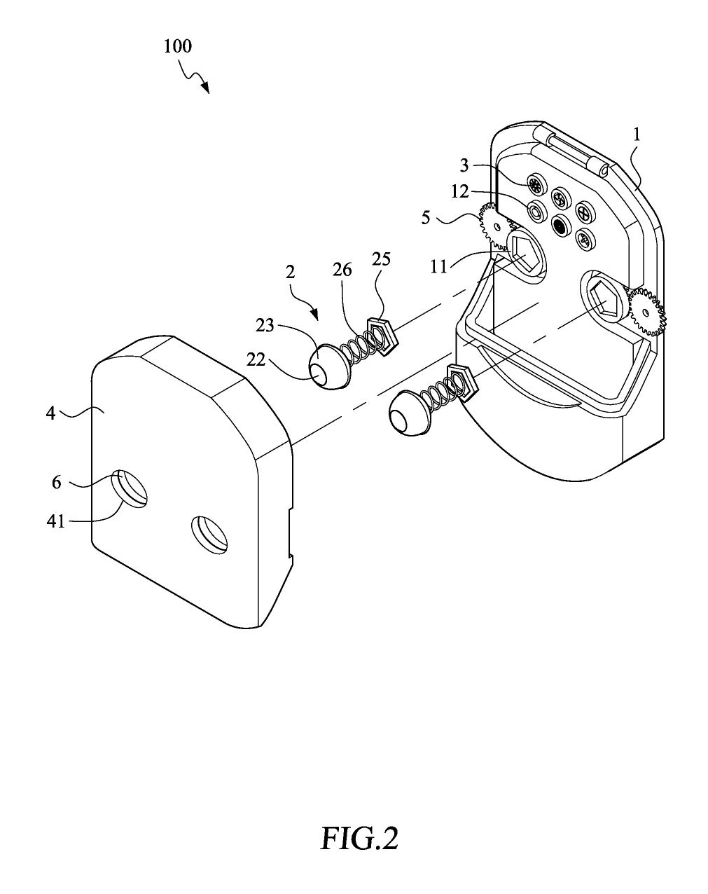

Referring to FIGS. 1 to 3. An ocular surgery training device 100 of an embodiment according to the present invention includes a base body 1, an eye means 2, and a surgery model component 3.

The base body 1 has an eye seat 11 and a receiving seat 12.

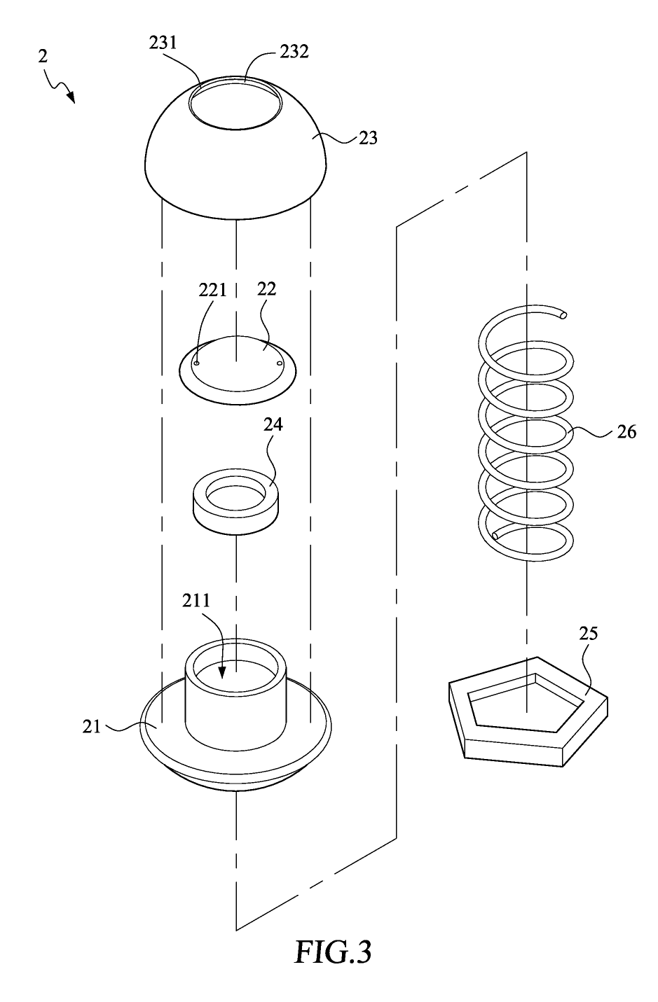

The eye means 2, which is disposed on the eye seat 11 of the base body 1, includes an eye base 21 having a containing groove 211, as shown in FIG. 3.

The eye means 2 further includes a cover body 22 which has an operation channel 221 communicated with the containing groove 211. In this embodiment, the cover body 22 is made of acrylic material and is transparent.

In this embodiment, the eye means 2 further includes a sclera component 23 surrounding the eye base 21. The sclera component 23 is formed with a hollow bore 231 corresponding to the cover body 22, and is formed with an engaging trough 232 for being engaged with the cover body 22, so that the cover body 22 can be securely engaged with the hollow bore 231.

The surgery model component 3 is a component that provides a surgery pathway as a surgery pathway model. The surgery pathway is a pathway on which a surgeon operates an operating tool. Since the cover body 22 and the sclera component 23 are detachably connected with each other, and the sclera component 23 and the eye base 21 are detachably connected with each other, the surgery model component 3 can be alternatively disposed on the receiving seat 12 or in the containing groove 211.

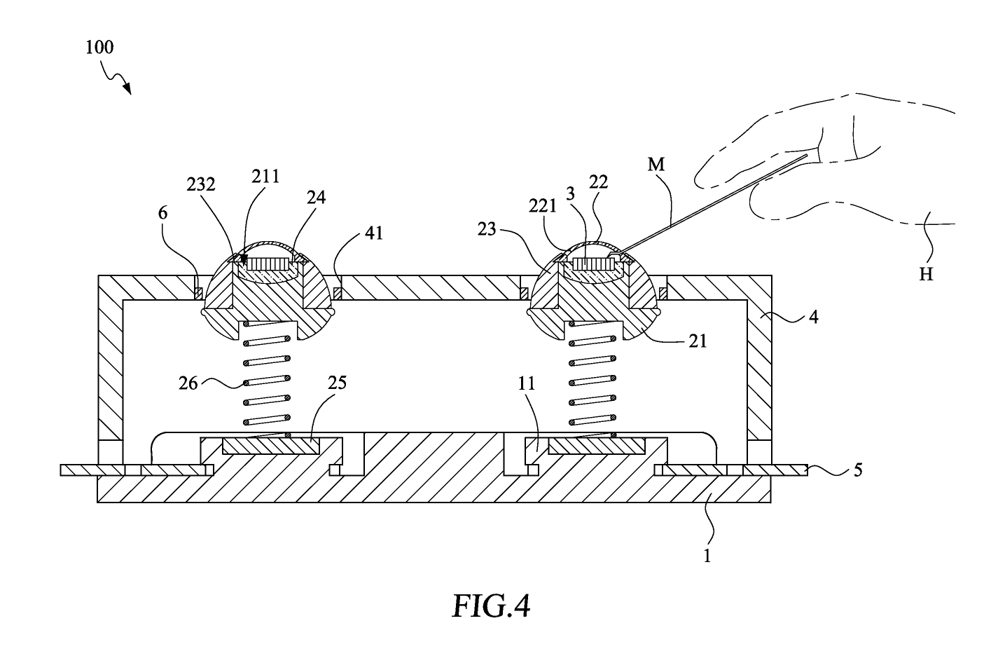

As shown in FIG. 4, in practical usage, a surgeon H can insert a surgical apparatus M into the containing groove 211 via the operation channel 221, and move the surgical apparatus M along the surgery pathway of the surgery model component 3 to carry out an ocular surgery training. In this embodiment, the base body 1 is provided with a plurality of the receiving seats 12 on which the surgery model components 3 with different shapes and surgery pathways can be disposed. It thus can simulate various ocular surgeries since various surgery model components 3 disposed on the containing groove 211 can be chosen.

In a preferred embodiment, the device further include an underlay component 24 for adjusting height of the surgery model component 3 that is supposed to be disposed on to thus make the height of the surgery pathway of a simulating surgery more realistic and accurate. And the ocular surgery training device 100 further includes a mask body 4 which covers the base body 1 and is formed with an orbital bore 41 corresponding to the eye means 2, and thus the ocular surgery training device 100 looks like a human face so as to make the simulating surgery training more lifelike.

In a preferred embodiment, the ocular surgery training device 100 further includes a gear component 5 rotatably mounted on the base body 1, and the eye seat 11 is also rotatably mounted on the base body 1 and is engaged with the gear component 5. Thus the eye seat 11 can be driven to be rotated by turning the gear component 5 in an attempt to adjust the angle of the eye means 2.

In a preferred embodiment, the eye means 2 is provided on the eye seat 11 by means of a seat body 25, and an elastic component 26 is connected between the seat body 25 and the eye base 21. Thus the eye means 2 may be vibrating when the surgeon H is in the ocular surgery training so as to make the simulating surgery training more lifelike. Furthermore, the device may further include a sensing wire 6 surrounding around the eye means 2. If the force and the movement by the surgeon H during the simulating surgery training is too strong to contact the eye means 2 with the sensing wire 6, the sensing wire 6 can sense the contact and further issue a notice, such as a sound and/or a light, to warn the surgeon H. Accordingly, the surgeon H may be aware of his mistake and thus operate the simulating surgery training with a better force and movement.

The above description should be considered as only the discussion of the preferred embodiments of the present invention. However, a person skilled in the art may make various modifications to the present invention. Those modifications still fall within the spirit and scope defined by the appended claims.

What is claimed is:

1. An ocular surgery training device, comprising:
a base body provided with a receiving seat;
an eye means, which is provided on the base body, including an eye base and a cover body, the eye base having a containing groove, and the cover body having an operation channel communicated with the containing groove; and
a surgery model component replaceably provided between the receiving seat and the containing groove.

2. The ocular surgery training device as claimed in claim 1, wherein the eye means further includes a sclera component which is provided as surrounding the eye base and is formed with a hollow bore corresponding to the cover body.

3. The ocular surgery training device as claimed in claim 2, wherein the sclera component is formed with an engaging trough for being engaged with the cover body.

4. The ocular surgery training device as claimed in claim 1, further comprising an underlay component for adjusting height of the surgery model component that is disposed on the underlay component.

5. The ocular surgery training device as claimed in claim 1, wherein the eye means is provided on the base body through a seat body, and an elastic component is connected between the seat body and the eye base.

6. The ocular surgery training device as claimed in claim 1, wherein the base body has an eye seat on which the eye means is disposed.

7. The ocular surgery training device as claimed in claim 6, further comprising a gear component rotatably mounted on the base body, wherein the eye seat is engaged with the gear component for being rotated with regard to the base body.

8. The ocular surgery training device as claimed in claim 1, further comprising a sensing wire provided around the eye means.

9. The ocular surgery training device as claimed in claim 1, further comprising a mask body covering the base body, wherein the mask body is formed with an orbital bore corresponding to the eye means.
